(19) United States
(12) Patent Application Publication
(10) Pub. No.: US 2013/0243978 A1
(43) Pub. Date: Sep. 19, 2013

(54) USE OF COMPOSITION FOR IMPROVING INKJET PRINTING PROPERTIES AND AN INKJET RECORDING SHEET

(71) Applicants: Juha Lindfors, Helsinki (FI); Sami Puttonen, Helsinki (FI)

(72) Inventors: Juha Lindfors, Helsinki (FI); Sami Puttonen, Helsinki (FI)

(21) Appl. No.: 13/881,477

(22) PCT Filed: Nov. 8, 2011
(86) PCT No.: PCT/FI2011/050993

§ 371 Date: May 10, 2013

(30) Foreign Application Priority Data
Nov. 8, 2010 (FI) 20106170

(51) Int. Cl. B41M 5/52

(52) U.S. Cl. CPC B41M 5/5218
USPC 428/32.21

(57) ABSTRACT

The invention relates to a use of a composition comprising polyaluminium compound and starch solution for improving inkjet printing properties of a ink jet recording sheet by coating or applying it onto the inkjet recording sheet, the inkjet recording sheet comprising wood or lignocellulosic fibre material. The invention relates also to an ink jet recording sheet.

The invention relates to use of composition for improving inkjet printing properties, and an inkjet recording sheet according to the preambles of the enclosed independent claims.

Inkjet printing is one of the digital printing methods and it is widely used technology in printers intended for office and home use, as well as for commercial printing. In digital printing the printed document is directly produced from an electronic data file, whereby every print may be different from each other as no permanent master is required. Because the interest in digital printing is increasing, also the demand for cost effective recording substrates suitable for high-speed inkjet printing presses may be expected to increase.

In inkjet printing droplets of ink are ejected through a nozzle at high speed towards a recording sheet. Inkjet printing makes specific demands on the printing substrate, which usually is a recording sheet made of paper or board. For example, printed ink colour density, ink absorption, ink drying time, Cobb60 values, water fastness and print mottling are important variables that are optimised in making of inkjet recording sheets. Preferably, an inkjet recording sheet would provide a high image quality while using inexpensive raw materials.

Recording sheets, such as paper, comprising lignocellulosic fibres are usually surface sized or coated in order to meet the demands of inkjet printing. It is known to use silica-based coatings, which are expensive compared to conventional coatings used in paper industry. EP 1775141 discloses a recording sheet where a divalent metal salt, particularly calcium chloride, is applied on the substrate surface.

Aluminium may form polyaluminium compounds with different anions. Examples of such compounds are polyaluminium chloride (PAC) and polyaluminium sulphate (PAS).

Polyaluminium chloride is an inorganic polymer having a general formula Alₙ(OH)ₘCl₍₃ₙ₋ₘ₎. In a solution it is typically present as a highly charged aluminium complex Al₁₃O₄(OH)₂₄(H₂O)₁₂⁷⁺ or AlO₄Al₁₂(OH)₂₄(H₂O)₂₄⁷⁺. It may be produced by the addition of Na₂CO₃ to AlCl₃ or by reacting aluminium hydrate with hydrochloric acid. Polyaluminium chloride is used in papermaking as a retention aid or for internal sizing.

Polyaluminium sulphate may be produced by adding sodium, magnesium or calcium hydroxide, or carbonate to liquid aluminium sulphate. It may also be produced by mixing aluminium containing material, such as an aluminium hydroxide, with an acidic compound, such as sulphuric acid or a mixture of acids comprising sulphuric acid, and heating the said mixture to a temperature of 150-250° C. and thereafter cooling the mixture to 130° C. or lower.

It is known to use aluminium compounds in paper coatings compositions in order to improve the physical properties of the paper. For example, U.S. Pat. No. 6,232,395 discloses coating of ink jet paper with a composition comprising special three-component latex, glycerol and hydrated aluminium chloride.

FR 2343082 discloses use of pigment dispersion comprising hemi-hydrated calcium sulphate and aluminium hydroxide in presence of depolymerised starch. It is stated that the pigment dispersion is easier to disperse mechanically and better whiteness is obtained.

An object of this invention is to minimise or even eliminate the disadvantages existing in the prior art.

An object is also to provide a use of a composition which improves, or at least maintains the inkjet properties, especially gamut (colour richness) of the paper or paperboard, while using less expensive starting materials and simple coating compositions.

A further object of this invention is to provide an inkjet recording sheet, which has improved properties for inkjet printing, especially gamut (colour richness).

These objects are attained with the invention having the characteristics presented below in the characterising parts of the independent claims.

Typical use according to the present invention of a composition comprising polyaluminium compound and starch solution for improving inkjet printing properties of a ink jet recording sheet is by coating or applying the composition onto the inkjet recording sheet, the inkjet recording sheet comprising wood or lignocellulosic fibre material.

Typical inkjet recording sheet according to the present invention comprises a sheet substrate comprising wood or lignocellulosic fibre material, the sheet substrate having at least one surface, which has been coated with or onto which has been applied to a composition comprising polyaluminium compound and starch.

Now it has been surprisingly found out that use of a composition comprising polyaluminium compound, preferably polyaluminium chloride or polyaluminium sulphate or their mixture, and starch provides improved properties for inkjet printing when the composition is applied or coated on a recording sheet substrate comprising wood and/or cellulose fibres. The recording sheet that is obtained by using the composition has especially improved colour richness, i.e. gamut, which is important property in ink jet printing and image reproduction. The improvement which is achieved in the printing result in unexpected and provides many advantages. It is also a surprising that the obtained improvement may be achieved by using simple starting materials such as polyaluminium chloride or polyaluminium sulphate and starch, which makes the employed coating composition easy and inexpensive to produce.

The obtained recording sheet has also similar or even better substrate ink jet printing properties, which affect the inkjet printability, such as gamut, contact angle, Cobb60, HST, water fastness and print density black, cyan, magenta and/or yellow values that has earlier been achieved with expensive specialty coating pigments and compositions. The present invention provides thus surprisingly good and inexpensive recording sheet alternative for inkjet printing, especially for image reproduction.

In this application the term colour gamut or simply gamut, i.e. colour richness, is understood as total range of colors than are reproduced with given set of inks, printing device and on given paper stock. For a gamut measurement certain print layout is printed with defined ink-paper-print device combination. Minimum requirement for this print layout is to include solid color fields of primary and secondary colors. In subtractive color model cyan, magenta and yellow are the primary colors and red, green and blue are the secondary colors. According to one embodiment of the invention the inkjet recording sheet has a colour gamut value >7500.

Spectrophotometric measurement device is to be employed for CIE L*, a,* b*-measurements (later L*, a*, b*). For measurements Techkon SpectroDens-device is used. L*, a*, b*-values are measured from solid primary and secondary color patches and a*, b*-values are used as (x, y) values for X, Y-co-ordinates. These six (x, y)-values creates an uneven planar hexagon and area inside this hexagon is described as reproducible color area, which is the color gamut.

According to one embodiment of the invention the polyaluminium compound is polyaluminium chloride or polyaluminium sulphate or their mixture. Polyaluminium chloride is understood in this application as pre-polymerised aluminium substance, which may be presented also by the general formula Al₂(OH)ₓCl₆₋ₓ, where 0<x<6. The degree of neutralisation, i.e. the replacement of Cl ions with OH ions, may be expressed by using the unit basicity. The basicity of polyaluminium compound may be generally expressed by the following formula

% Basicity=100×[OH]/3[Al]

The higher the basicity, the higher the degree of neutralisation. Depending on basicity of polyaluminum chloride fewer ions have a 3⁺ charge, and more ions are high charged, averaging 5⁺ to 7⁺. The basicity of polyaluminium chloride is typically 36-85%.

Typically polyaluminium chloride may be used as 20-40 weight-%, more typically as 30-40 weight-% aqueous solution. Thus the solution may have aluminium content of 4.5-11.8% and its Al₂O₃ content is 8.5-22.3%. pH of a solution of polyaluminium chloride is typically 0.5-4.2 and its specific gravity (25° C.) is typically 1210-1370 kg/m³.

Polyaluminium sulphate may be used as solution or in particle form. The solid content in a polyaluminium sulphate solution may be around 50%. The solution may have aluminium content around 4.0-4.5% and its Al₂O₃ content is 7.5-9%. pH of a solution (1% solution at 25° C.) of polyaluminium sulphate may be around pH 4 and its specific gravity (25° C.) may be around 1200-1300 kg/m³. The basicity of polyaluminium sulphate may be around 15-25%.

According to one embodiment of the invention the amount of polyaluminium compound, such as polyaluminium chloride or polyaluminum sulphate or their mixture, preferably polyaluminium chloride, in the composition is >0.01 parts, typically 0.05-20 parts, more typically 0.1-15 parts, still more typically 0.2-10 parts, preferably 0.2-8 parts, more preferably 2-7 parts. The amount of polyaluminium compound, such as polyaluminium chloride or polyaluminum sulphate or their mixture, preferably polyaluminium chloride, in the composition is >0.01 weight-%, typically 0.05-16.7 weight-%, more typically 0.1-13 weight-%, still more typically 0.2-9.0 weight-%, preferably 0.2-7.4 weight-%, more preferably 2-6.5 weight-%, the percentages being calculated to total dry weight of polyaluminium compound and starch. According to one embodiment of the invention the composition solely consists of a polyaluminium compound, starch solution and optionally a small amount, less than 5 weight-%, typically 0.5-3 weight-% additives, such as preservatives, biocides, dispersing agents, defoaming agents, lubricants and/or hardeners, but is free from pigment.

According to one embodiment of the invention the composition further comprises a pigment. The pigment may be an inorganic pigment, such as clay, ground or precipitated calcium carbonate, kaolin, calcinated kaolin, talc, titanium dioxide, chalk, satine white, barium sulphate, or calcium sulphate dihydrate, or a plastic pigment or silica. The composition may comprise also a plurality of different pigments, either inorganic or organic, or both. Typically, when the composition comprises both polyaluminium compound, such as polyaluminium chloride or polyaluminium sulphate or their mixture, and a pigment, such as calcium sulphate dihydrate, the amount polyaluminium compound may be >0.01 parts, typically 0.05-20 parts, more typically 0.1-15 parts, still more typically 0.2-10 parts, preferably 0.2-8 parts, more preferably 2-7 parts and the amount of pigment may be 0.1-80 parts, typically 10-80 parts, more typically 10-70 parts, preferably 10-60 parts, more preferably 10-50 parts. Consequently, the amount of polyaluminium compound in the composition may be >0.01 weight-%, typically 0.05-16.7 weight-%, more typically 0.1-13 weight-%, still more typically 0.2-9.0 weight-%, preferably 0.2-7.4 weight-%, more preferably 2-6.5 weight-%, the percentages being calculated to total dry weight of polyaluminium compound, starch and pigment.

Preferably the pigment is calcium sulphate dihydrate. According to one embodiment of the invention the composition comprises calcium sulphate dihydrate, CaSO₄×2 H₂O, possessing a monoclinic crystal structure. The use of a composition, which comprises both polyaluminium compound, such as polyaluminium chloride, polyaluminium sulphate or their mixture, and calcium sulphate dihydrate improves the ink jet properties of a recording sheet, especially gamut values.

Generally, any calcium sulphate dihydrate may be used. The particle size D₅₀ of the calcium sulphate dihydrate in the composition is usually <50 μm and typically >0.7 μm. Typically calcium sulphate dihydrate has a particle size D₅₀ which is 0.1 μm≦D₅₀<5.0 μm, more preferably 0.1 μm≦D₅₀<4.0 μm, still more preferably 0.5 μm≦D₅₀<4.0 μm. Preferably, the width of the particle size distribution WPSD of calcium sulphate dihydrate is below 2.5, more preferably below 2.0, still more preferably below 1.5. The width of the particle size distribution is given as WPDS=(D₇₅−D₂₅)/D₅₀, and it describes the homogeneity of the particle size distribution. A small WPDS value indicates a narrow particle size distribution, which improves the light scattering and opacity characteristics of the calcium sulphite dihydrate.

The calcium sulphate dihydrate particles used in the present invention may be of any shape. Preferably, the calcium sulphate dihydrate particles have a shape ratio SR, which is at least 1.0, more preferably from 2.0 to 50, still more preferably from 2.0 to 40. The shape ratio SR is given as the ratio between the maximum particle length to the maximum particle thickness. Preferably the used calcium sulphate dihydrate particles have an aspect ratio AS, which is from 1.0 to 10, more preferably from 1.0 to 5.0. The aspect ratio of a particle describe the ratio between the particle length to the particle broadness, i.e. the aspect ratio may be given as the ratio between the longest and shortest dimensions of the particle and is defined more specifically as the ratio of the longest and shortest particle radii that pass through the geometric centre of the particle. The shape and aspect ratios describe the shape and geometry of the particles. It has been found out that the shape of the particles may have an impact to the properties of the final ink receiving coating layer. In other words, preferably the calcium sulphate dihydrate particles are small, flat and equal of size. Naturally calcium sulphate dihydrate particles of any shape and any suitable size may be employed.

The calcium sulphate dihydrate may comprise additives, such as dispersants, surfactants or biocides. For example, the amount of dispersing agent used may be from 0.01 to 5.0 weight-%, preferably from 0.05 to 3.0 weight-%, based on the weight of calcium sulphate dihydrate. The calcium sulphate dihydrate may be prepared by grinding, crystallization or precipitation. Preferably calcium sulphate dihydrate particles are obtained by crystallization or precipitation. Calcium sulphate dihydrate may also be a mixture of different calcium sulphate dihydrates prepared by different above-mentioned processes. One possible process for preparing suitable calcium sulphate dihydrate has been described in publication WO 2008/092991. The calcium sulphate dihydrate may be obtained by a process, where calcium sulphate hemihydrate and/or calcium sulphate anhydrite are contacted with water so that a calcium sulphate dihydrate is obtained as a reaction product, the dry matter content of the reaction mixture being from 34 to 84 weight-%, preferably from 40 and 84 weight-%, more preferably from 50 to 80%, and most preferably from 57 to 80 weight-% in order to obtain a calcium sulphate dihydrate, which comprises crystals that are small, flat and of as equal size as possible. It is possible to obtain crystals of different crystal size and shape factor by adjusting the dry matter content of the process.

During preparation of calcium sulphate dihydrate the temperature of the water in the reaction mixture may be from 0° C. to 100° C., preferably from 0° C. to 80° C., more preferably from 0° C. to 50° C., even more preferably from 0° C. to 40° C., sometimes even from 0° C. to 25° C. Water may also be added to the reaction mixture in the form of water vapour. The initial pH of the reaction mixture is typically between 3.5 and 9.0, preferably between 4.0 and 7.5. pH may be regulated by using addition of an aqueous solution of NaOH and/or H₂SO₄, typically a 10% solution of NaOH and/or H₂SO₄.

Starting material for calcium sulphate dihydrate preparation is typically β-calcium sulphate hemihydrate, which may be prepared by heating gypsum raw material to a temperature of between 140° C. and 300° C., preferably from 150 to 200° C., preferably as fast as possible by using flash calcination, e.g. fluid bed calcination. Also soluble forms of calcium sulphate anhydrite, obtained by calcination of gypsum raw material, may be used as starting material.

Crystal habit modifier may be used in the production process of calcium sulphate dihydrate, but it is not mandatory. The crystal habit modifier may be added to water before it comes into contact with starting material comprising hemihydrate and/or the anhydrite. The crystal habit modifier is preferably a compound having in its molecule one or several carboxylic or sulphonic acid groups, or a salt thereof; or an inorganic acid, oxide, base or salt; or an organic compound, such as an alcohol, an acid or a salt; or a phosphate; or a cationic or non-ionic surfactant. The crystal habit modifier is preferably used in an amount of 0.01 to 5.0%, most preferably 0.02-1.78%, based on the weight of the calcium sulphate hemihydrate and/or calcium sulphate anhydrite. The crystal habit modifier may also be totally omitted.

According to one embodiment the composition comprises calcium sulphate dihydrate both in dissolved in the starch solution and in solid particulate form. In other words, part of the calcium sulphate in the composition is dissolved in the liquid phase of the composition while part of the calcium sulphate remains in the solid form. Typically the liquid phase of the composition is a saturated solution in regard of calcium sulphate dihydrate. Calcium sulphate dihydrate may be added to the composition in amount which is equal or larger than 2.5 g per 1 litre of starch solution having a dry matter content of 15 weight-%, which amount ensures the formation of saturated calcium sulphate dihydrate solution. Typically the amount of calcium sulphate dihydrate, which is dissolved in the starch solution, is >400 ppm, preferably >500 ppm, more preferably >600 ppm, still more preferably >700 ppm. The amount of dissolved calcium sulphate is naturally dependent on the total amount of calcium sulphate dihydrate that is used in preparation of the composition, and also on other components of the composition, such as starch, polyaluminium compound(s) and other pigments. It has been observed that when calcium sulphate dihydrate exists both in dissolved and solid form, the properties associated with the porosity are improved in the recording sheet substrate coated with the composition. For example, the air permeability of the recording sheet is clearly reduced, rendering the recording sheet more suitable for inkjet printing.

According to one embodiment of the invention, the composition comprises a polyaluminium compound, such as polyaluminium chloride or a polyaluminium sulphate or their mixture, and starch, but it is substantially free of pigment particles. Also in this case the composition may comprise also conventional paper coating or surface sizing additives.

Starch used in the composition may be any suitable native starch, such as potato, rice, corn, waxy corn, wheat, barley or tapioca starch. Starches having an amylopectin content >80%, preferably >95% are advantageous. The starch solution may comprise non-ionic or cationic starch. Cationic starch comprises cationic groups, such as quaternized ammonium groups. Degree of substitution (DS), indicating the number of cationic groups in the starch on average per glucose unit, is typically 0.01-0.20. Non-ionic starch, i.e. amphoteric starch, may comprise both anionic and cationic groups, but has not an overall charge. Degraded starch is obtained by subjecting the starch to oxidative, thermal, acidic or enzymatic degradation, oxidative degradation being preferred. Hypochlorite, peroxide sulphate, hydrogen peroxide or their mixtures may be used as oxidising agents. Degraded starch has typically an average molecular weight (Mn) 500-10 000, which can be determined by known gel chromatography methods. The intrinsic viscosity is typically 0.05 to 0.12 dl/g, determined, for example, by known viscosimetric methods.

In another embodiment of the invention, the starch solution comprises anionic starch. For example, anionic starch may be used when the composition is used for surface sizing or to replace part of the conventional surface sizing compositions.

Amount of starch solution in the composition is <95, normally 5-95 parts, typically 10-95 parts, more typically 20-95 parts, preferably 30-95 parts, more preferably 40-95 parts. Starch solution is a water solution of starch that has been cooked according to methods that are as such well-known for a person skilled in the art.

It is also possible to employ chemically modified starches, such as hydroxyethyl or hydroxypropyl starches and starch derivatives. Also other polysaccharides, e.g. dextrin, may be used to replace starch wholly or partially.

The composition may comprise also conventional paper coating or surface sizing additives. Possible additives are, for example, preservatives, biocides, dispersing agents, defoaming agents, lubricants and/or hardeners. The amount of other additives is 0-20 parts, typically 0.1-3 parts.

The solid content of the coating composition may be 6-25 weight-%, preferably 8-20 weight-%, more preferably 10-15 weight-%, even more preferably 13-15 weight-%.

The recording substrate in sheet form that is used for the inkjet printing and coated with the present composition comprises wood or lignocellulosic fibre material. The substrate may comprise fibres from hardwood trees or softwood trees or a combination of both fibres. The fibres may be obtained by any suitable pulping or refining technique normally employed in paper making, such as thermomechanical pulping (TMP), chemimechanical (CMP), chemithermomechanical pulping (CTMP), groundwood pulping, alkaline sulfate (kraft) pulping, acid sulfite pulping, and semichemical pulping. The substrate may comprise only virgin fibres or recycled fibres or a combination of both. The weight of the recording sheet substrate is 30-800 g/m², typically 30-600 g/m², more typically 50-500 g/m², preferably 60-300 g/m², more preferably 60-120 g/m², even more preferably 70-100 g/m².

According to one embodiment of the present invention composition comprising polyaluminium compound, for example polyaluminium chloride or polyaluminium sulphate or their mixture, and starch may be applied to the substrate surface in amount 0.1-7 g/m²/side, preferably 0.2-6 g/m²/side, more preferably 0.3-5 g/m²/side. The composition is applied or coated on at least one of the two large surfaces of the substrate.

According to one embodiment the inkjet recording sheet coated with a composition comprising polyaluminium compound and starch has a contact angle (0.05 s)≧50°, ≧70°, preferably ≧80°, more preferably ≧85°, sometimes even ≧90°, measured by using the standard method Tappi 565 pm-96. An increase in the contact angle indicates an increase in the hydrophobic properties of the measured surface. Most of the inks that are used in the inkjet printing are water based and an increased hydrophobicity of the recording sheet improves the controllability of the ink behaviour in the inkjet printing process.

According to one embodiment the inkjet recording sheet coated with a composition comprising polyaluminium compound and starch has an air permeability value <600 ml/min, preferably <500 ml/min, more preferably <400 ml/min, sometimes even <300 ml/min or <200 ml/min, measured by using standard method ISO 5636-3:1992. Air permeability values indicate the porosity of the substrate. For recording substrate intended for inkjet printing a small air permeability value is preferred, as it indicates low porosity of the substrate, which prevents the spreading of the ink inside the substrate.

According to an embodiment the inkjet recording sheet coated with a composition comprising polyaluminium compound and starch has an ink absorption value <300 s, typically <200 s, more typically <100 s. The ink absorption value is measured by using a Hercules sizing tester (HST), using standard method TAPPI T530 pm-89.

Water fastness indicates how much the printed ink spreads when contacted with water. It is measured by printing recording sheet sample with HP Business Inkjet 2800 drop-on-demand inkjet, equipped with HP11 ink cartridges (HP product code: cyan C4836A, magenta C4837A) and HP11 printheads (HP product code: cyan C4811 A, magenta C4812A). Solid cyan and solid magenta test patch, size 50 mm×50 mm, are printed on recording sheet, and the sheet is allowed to set for one minute. The densities of printed patches are measured. After that the sample is placed vertically in water bath, where it is soaked for one minute. After soaking, sample is lifted out, excess water is drained and it is put in a heating chamber until it is totally dry. Temperature of the heating chamber is set to 45° C. and drying time is maximum 15 minutes. Densities of test prints are measured anew after drying and difference between density value measured before soaking and density value after soaking and drying is reported as loss of density, given as percentages of original density value.

It has been observed that the water fastness properties of present recording sheet which has been coated by using composition comprising a polyaluminium compound and starch may be improved when compared to conventional inkjet recording sheets. The inkjet recording sheets according to one embodiment may have an ink loss value typically <55%, preferably <45%, more preferably <40%.

Ink density black, ink density magenta and ink density cyan are measured by using standard methods ISO 5-3:1995 and ISO 5-4:1995. Ink densities are measured with Techkon SpectroDens-densitometer, manufactured by Techkon GmbH. For density and mottling tests the samples are printed with HP Photosmart Pro B8850 drop-on-demand inkjet printer equipped with HP Pigment Ink Cartridges C9412A-C9419A. Samples for print through tests are printed with Kodak Versamark VX5000 continuous inkjet printer and Kodak inks F3001 for cyan, FV3002 for magenta, FV3003 for black and FV3005 yellow are used for printing. The inkjet recording sheet, which has been coated by using a composition comprising polyaluminium compound and starch, may have at least one ink density value >1.1, more typically >1.2, preferably >1.3, selected from ink density black, ink density magenta and ink density cyan, and measured by using standard methods ISO 5-3:1995, ISO 5-4:1995, when printed with HP Photosmart Pro B8850 and with the inks as described above. The inkjet recording sheet, which has been coated by using a composition comprising polyaluminium compound and starch, has preferably an ink density black value >1.7, preferably >1.8, measured by using standard methods ISO 5-3:1995, ISO 5-4:1995, when printed with HP Photosmart Pro B8850 and with inks as described above. The inkjet recording sheet, which has been coated by using a composition comprising polyaluminium compound and starch, has preferably an ink density magenta value >1.1, preferably >1.2, measured by using standard methods ISO 5-3:1995, ISO 5-4:1995, when printed with HP Photosmart Pro B8850 and with inks as described above. The inkjet recording sheet, which has been coated by using a composition comprising polyaluminium compound and starch, has preferably an ink density cyan value >1.2, preferably >1.3, measured by using standard methods ISO 5-3:1995, ISO 5-4:1995, when printed with HP Photosmart Pro B8850 and with inks as described above. Still more preferably, the inkjet recording sheet shows all the above described ink density black magenta and cyan values simultaneously.

Print mottling is a term used to describe irregularities in the amount of ink and gloss of the print, giving rise to a spotted print appearance. Print mottling is measured by using an image analyser and a wavelet transform, by using equipment TAPIO® PapEye manufactured by Only Solutions, TAPIO Technologies, Espoo, Finland. First the field to be measured is scanned and the degree of imperfection is determined according to seven stages of resolution: 0.17 mm; 0.34 mm; 0.67 mm; 1.34 mm; 2.54 mm; 5.10 mm; 10.2 mm. The values between the resolution stages are interpolated and the print mottling is presented as a sum of these values. The mottling index has a range of 0 to 100, but in practice it lies between 1 and 10. Five replicates of each trial point are carried out. The method is not sensitive to the orientation of the sample. Inkjet recording sheet according to one embodiment may have mottling index for light tones <5, preferably <4.5, more preferably <4.3 arbitrary units, the light tone comprising an overprint of cyan 40% screen together with magenta 40% screen. Inkjet recording sheet according to one embodiment may have mottling index for dark tones <8, preferably <7, more preferably <6 arbitrary units, the dark tone comprising an overprint of cyan 80% screen together with magenta 80% screen, overprint.

Print-through values describe unwanted appearance of a printed image on the reverse side of the printed recording sheet. Print-through is tested with the following method, which is based on the evaluation of CIELAB (ΔE*) or CIE94 (ΔE94) colour differences between studied and reference areas. The studied area is obtained with aid of a flatbed scanner from the reverse side of the print, and the reference area is obtained from an unprinted area of the paper in question. The values for print-through severity are calculated with a Matlab program maintained by the MathWorks. The colour differences ΔE* or ΔE94 are calculated point wise, and the mean value of colour differences express the intensity of print-through. Inkjet recording sheet according to one embodiment may have print-through value <9, preferably <8, more preferably <7, given in arbitrary units. For inkjet recording sheets the value is preferably as low as possible.

According to an embodiment of the invention the inkjet recording sheet coated with a coating comprising polyaluminium compound has a Cobb60 value <70 g/m², preferably <65 g/m², more preferably <60 g/m², measured by using standard method ISO 535:1991. Cobb60 value gives a value for the water absorption to the recording sheet. The smaller the Cobb 60 value is, the smaller is the amount of water that is absorbed by the sheet. For inkjet recording sheets a small Cobb60 value is sometimes an advantage in order to obtain good printing results with water-soluble inks. The Cobb60 values obtained by using the composition according the present invention may be compared to values that are conventionally obtained by hydrophobic sizing.

In this application composition of a coating mixture is given by giving the total amount of starch and possible pigment(s) value 100, and calculating the amounts of other components relative to the total amount of the starch and possible pigment(s) (pph). Proportions of all components are given as active substances.

### EXPERIMENTAL

The coating composition is prepared using heated magnetic stirrer and decanter. First the starch is cooked, whereby a defined amount of water and starch (Stabilys A020, Roquette) are added in to a decanter. After this the mixture is heated to the boiling point and cooked for 30 minutes in a heated magnetic stirrer. After the starch is cooked other components are added under proper shear action which ensures thorough mixing of the components with each other. The compositions are prepared according the following Table 1. The desired solid content of the coating composition is 13-15 weight-%.

In compositions KemiraPAC A18 is used as polyaluminium chloride and Kemira Kemwhite CG80 is used as calcium sulphate dihydrate.

TABLE 1
Components of the reference composition (Ref.) and different test
compositions (S1-S8).

| Component | Ref. | S1 | S2 | S3 | S4 | S5 | S6 | S7 | S8 |
|---|---|---|---|---|---|---|---|---|---|
| Starch | 100 | 100 | 100 | 100 | 100 | 70 | 70 | 70 | 70 |
| Calcium sulphate | 0 | 0 | 0 | 0 | 0 | 30 | 30 | 30 | 30 |
| dihydrate | | | | | | | | | |
| Polyaluminium | 0 | 2 | 4 | 6 | 8 | 2 | 4 | 6 | 8 |
| chloride | | | | | | | | | |

Recording sheet substrate is 75 g/m² wood-free base paper including both hardwood and softwood pulps and filler. The coating compositions to be tested are applied to the base paper by using laboratory size press (manufacturer Mathis, type SP 5607) at a speed 2 m/min with 2 bar nip pressure. Using this combination of composition solid content, size press running speed and nip pressure, a pick up weight 2.5 g/m² per side is achieved for the samples. After the coating the sheets are dried and calendered. The drying temperature for samples is 60° C. for 90 seconds. Calendering is performed as so called soft calendering at ambient 25° C. temperature with nip load 75 kN/m.

Experiments are carried out in order to evaluate the samples for use in ink-jet printing. The properties selected for the evaluation are color gamut, density (black), density (magenta) and density (cyan). The test prints are printed with HP Photosmart Pro B8850 equipped with HP Vivera 38 inks. The colour densities are measured with Techkon SpectroDens. Results are given in Table 2.

TABLE 2
Experiments results for the reference composition (Ref.) and different test
compositions (S1-S8).

| Property | Ref. | S1 | S2 | S3 | S4 | S5 | S6 | S7 | S8 |
|---|---|---|---|---|---|---|---|---|---|
| Gamut | 7199 | 8487 | 9273 | 9546 | 9660 | 9022 | 9355 | 9710 | 9539 |
| Density, | 1.66 | 1.79 | 1.91 | 1.93 | 1.88 | 1.98 | 1.96 | 2.00 | 1.95 |
| black | | | | | | | | | |
| Density, | 1.00 | 1.11 | 1.29 | 1.29 | 1.32 | 1.35 | 1.35 | 1.40 | 1.37 |
| magenta | | | | | | | | | |
| Density, | 1.10 | 1.24 | 1.38 | 1.43 | 1.47 | 1.30 | 1.37 | 1.55 | 1.46 |
| cyan | | | | | | | | | |

From the obtained results it may be concluded that the increasing amount of polyaluminium chloride in the composition increases the gamut and colour density values. The improvement is even more pronounced when a composition comprising both polyaluminium chloride and calcium sulphate dihydrate is used.

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. Use of a composition comprising polyaluminium compound and starch solution for improving inkjet printing properties of a ink jet recording sheet by coating or applying the composition onto the inkjet recording sheet, the inkjet recording sheet comprising wood or lignocellulosic fibre material.

2. Use according to claim 1, characterised in that the polyaluminium compound is polyaluminium chloride or polyaluminium sulphate or their mixture.

3. Use according to claim 1, characterised in that the amount of polyaluminium compound in the composition is >0.01 parts, typically 0.05-20 parts, preferably 0.2-8 parts, more preferably 2-7 parts.

4. Use according to claim 1, characterised in that the amount of polyaluminium compound in the composition is >0.01 weight-%, typically 0.05-16.7 weight-%, preferably 0.2-7.4 weight-%, more preferably 2-6.5 weight-%, the percentages being calculated to total dry weight of polyaluminium compound and starch.

5. Use according to claim 1, characterised in that the amount of starch solution in the composition is <95 parts, typically 5-95 parts, preferably 30-95 parts, more preferably 40-95 parts.

6. Use according to claim 1, characterised in that the starch solution comprises non-ionic or cationic starch.

7. Use according to claim 1, characterised in that the composition consists of a polyaluminium compound, starch solution and optionally a small amount, less than 5 weight-%, typically 0.5-3 weight-% additives, such as preservatives, biocides, dispersing agents, defoaming agents, lubricants and/or hardeners, and is free from pigment.

8. Use according to claim 1, characterised in that the composition further comprises a pigment.

9. Use according to claim 8, characterised in that the amount of pigment in the composition is 0.1-80 parts, preferably 10-60 parts, more preferably 10-50 parts.

10. Use according to claim 8, characterised in that the pigment is an inorganic pigment, such as clay, ground or precipitated calcium carbonate, kaolin or calcium sulphate dihydrate, or a plastic pigment or silica.

11. Use according to claim 10, characterised in that the pigment is calcium sulphate dihydrate.

12. Use according to claim 11, characterised in that the composition comprises calcium sulphate dihydrate both in dissolved in the starch solution and in solid particulate form.

13. Use according to claim 11, characterised in that the amount of calcium sulphate dihydrate dissolved in the starch solution is >400 ppm, preferably >500 ppm.

14. An inkjet recording sheet comprising a sheet substrate comprising wood or lignocellulosic fibre material, the sheet substrate having at least one surface, which has been coated with or onto which has been applied to a composition comprising polyaluminium compound and starch.

15. Inkjet recording sheet according to claim 14, characterised in that the polyaluminium compound is polyaluminium chloride or polyaluminium sulphate or their mixture.

16. Inkjet recording sheet according to claim 14, characterised in that the composition consists of a polyaluminium compound, starch and optionally a small amount, less than 5 weight-%, typically 0.5-3 weight-% additives, such as preservatives, biocides, dispersing agents, defoaming agents, lubricants and/or hardeners, and is free from pigment.

17. Inkjet recording sheet according to claim 14, characterised in that the composition further comprises a pigment.

18. Inkjet recording sheet according to claim 17, characterised in that the pigment is an inorganic pigment, such as clay, ground or precipitated calcium carbonate, kaolin or calcium sulphate dihydrate, or a plastic pigment or silica.

19. Inkjet recording sheet according to claim 14, characterised in that it has at least one ink density value >1.1, typically >1.2, preferably >1.3, selected from ink density black, ink density magenta and ink density cyan, and measured by using standard methods ISO 5-3:1995, ISO 5-4:1995.

20. Inkjet recording sheet according to claim 19, characterised in that it has an ink density black value >1.7, preferably >1.8, measured by using standard methods ISO 5-3:1995, ISO 5-4:1995.

21. Inkjet recording sheet according to claim 19, characterised in that it has an ink density magenta value >1.1, preferably >1.2, measured by using standard methods ISO 5-3:1995, ISO 5-4:1995.

22. Inkjet recording sheet according to claim 19, characterised in that it has an ink density cyan value >1.2, preferably >1.3, measured by using standard methods ISO 5-3:1995, ISO 5-4:1995.

23. Inkjet recording sheet according to claim 22, characterised in that it has a colour gamut value >7500.
